(19) United States
(12) Patent Application Publication
(10) Pub. No.: US 2023/0007092 A1
(43) Pub. Date: Jan. 5, 2023

(54) PREDICTION-BASED RESOURCE PROVISIONING IN A CLOUD ENVIRONMENT

(71) Applicant: Citrix Systems, Inc., Fort Lauderdale, FL (US)

(72) Inventors: Manbinder Pal Singh, Coral Springs, FL (US); Reng Zeng, Boca Raton, FL (US)

(21) Appl. No.: 17/365,147

(22) Filed: Jul. 1, 2021

(51) Int. Cl. H04L 29/08; G06F 9/455

(52) U.S. Cl. CPC H04L 67/16; G06F 9/45533; G06F 9/45558; G06F 2009/45562

(57) ABSTRACT

In one aspect, an example methodology implementing the disclosed techniques includes, by a computing device, determining a number of expected requests that cannot be processed using non-scalable resource instances that are available to process requests and provisioning one or more scalable resource instances based on the number of expected requests that cannot be processed using the non-scalable resource instances that are available to process requests. The provisioning of the one or more scalable resource instances includes executing a startup function configured to consume one or more processors of a started scalable resource instance for a predetermined duration, the started scalable resource instance being available to process a request subsequent to the predetermined duration.

### BACKGROUND

Cloud computing architectures enable ubiquitous, convenient, on-demand network access to a shared pool of configurable computing resources that can be rapidly provisioned and released with minimal management effort or cloud service provider interaction. Adoption of cloud computing has been aided by the recent advances in virtualization technologies, which allows for the creation of virtual version of something, e.g., a computing resource. Cloud computing models allow many different organizations (or “customers”) to manage the provisioning of computing resources (e.g., virtualized resources) as well as the allocation of the computing resources to end users. Cloud service providers typically offer scalable computing resources under various subscriptions where customers are billed based on actual resource consumption. Cloud computing implementations are generally expected to support a large scale of concurrent operations (e.g., thousands or millions or requests at the same time) as well as provide good user experience and low latency.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

As noted above, cloud computing implementations are expected to support large numbers of concurrent operations as well as provide good user experience and low latency. A primary challenge is to provide all of this (large scale concurrent operations, good user experience, and low latency) in a cost-effective manner. One solution is for an organization to host and manage a sufficient number of private or on-premises resources that are always started (e.g., powered on) and available for servicing a large number of concurrent requests. While this may provide low latency, this solution unfortunately is not cost effective and, in many instances, may be cost prohibitive. As another solution, cloud computing implementations may provide auto scaling features to scale up or scale down resources (i.e., automatically start up or shut down the resource instances) based on load (e.g., incoming requests) or other criteria. It is appreciated that there is a delay from when a resource is first started (brought up or powered on) to when the started resource is available to service a request. This delay is sometimes referred to as a “cold start” problem. Thus, auto scale does not adequately solve or address the latency issue since cold starts can add significant latency, especially during burst times.

Still another solution is for an organization to maintain a sufficient number of pre-warmed (e.g., pre-provisioned) resource instances that have been started and are available for servicing requests. In this instance, it can be expected that no cold starts would occur if the number of pre-warmed instances always exceeds the number of concurrent requests. However, other than the organization's private or on-premises resources discussed above, the organization typically procures scalable resources from third party cloud service providers under various subscriptions where the organization pays based on actual resource use. Thus, the solution unfortunately may not be cost effective since the organization pays for the pre-warmed instances even when these instances are not in use (e.g., not servicing any request). In addition, the organization may still encounter the cold start problem since these pre-warmed scalable instances may be shut down (e.g., scaled down to zero) after a period of idle time. Accordingly, described herein are embodiments of technologies that provide optimal provisioning of resource instances so as to provide good user experience and low latency in a cost-effective manner.

In accordance with one example embodiment provided to illustrate the broader concepts, systems, and techniques described herein, a method may include, by a computing device, determining a number of expected requests that cannot be processed using non-scalable resource instances that are available to process requests and provisioning one or more scalable resource instances based on the number of expected requests that cannot be processed using the non-scalable resource instances that are available to process requests. The provisioning of the one or more scalable resource instances includes executing a startup function configured to consume one or more processors of a started scalable resource instance for a predetermined duration, the started scalable resource instance being available to process a request subsequent to the predetermined duration.

According to another illustrative embodiment provided to illustrate the broader concepts described herein, a system includes a memory and one or more processors in communication with the memory. The processor may be configured to determine a number of expected requests that cannot be processed using non-scalable resource instances that are available to process requests and provision one or more scalable resource instances based on the number of expected requests that cannot be processed using the non-scalable resource instances that are available to process requests. The provisioning of the one or more scalable resource instances may include execution a startup function configured to consume one or more processors of a started scalable resource instance for a predetermined duration, the started scalable resource instance being available to process a request subsequent to the predetermined duration.

According to another illustrative embodiment provided to illustrate the broader concepts described herein, a method may include, by a computing device, determining a time a scalable resource instance is needed to service a request, determining an average cold start time to start up a new scalable resource instance, and sending a request to provision the scalable resource instance at a time that is the average cold start time prior to the time the new scalable resource instance is needed.

According to another illustrative embodiment provided to illustrate the broader concepts described herein, a system includes a memory and one or more processors in communication with the memory. The processor may be configured to determine a time a scalable resource instance is needed to service a request, determine an average cold start time to start up a new scalable resource instance, and send a request to provision the scalable resource instance at a time that is the average cold start time prior to the time the new scalable resource instance is needed.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 depicts an illustrative computer system architecture that may be used in accordance with one or more illustrative aspects of the concepts described herein.

FIG. 2 depicts an illustrative remote-access system architecture that may be used in accordance with one or more illustrative aspects of the concepts described herein.

FIG. 3 depicts an illustrative virtualized (hypervisor) system architecture that may be used in accordance with one or more illustrative aspects of the concepts described herein.

FIG. 4 depicts an illustrative cloud-based system architecture that may be used in accordance with one or more illustrative aspects of the concepts described herein.

FIG. 5 is a block diagram of an illustrative system architecture including a resource provisioning service deployed in a cloud computing environment, in accordance with an embodiment of the present disclosure.

FIG. 6 is a diagram showing an example allocation of requests between resource management services, in accordance with an embodiment of the present disclosure.

FIG. 7 is a diagram showing an example contextual management of computing resources, in accordance with an embodiment of the present disclosure.

FIG. 8 is a flow diagram of an illustrative process for provisioning scalable resource instances based on a predicted expected number of requests, in accordance with an embodiment of the present disclosure.

FIG. 9 is a flow diagram of an illustrative process for provisioning scalable resource instances in a just-in-time (JIT) manner, in accordance with an embodiment of the present disclosure.

### DETAILED DESCRIPTION

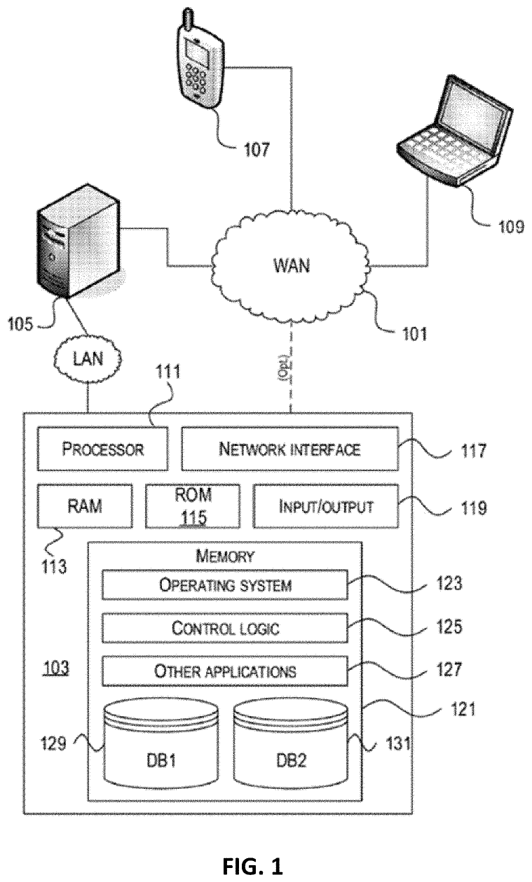

Computer software, hardware, and networks may be utilized in a variety of different system environments, including standalone, networked, remote-access (aka, remote desktop), virtualized, and/or cloud-based environments, among others. FIG. 1 illustrates one example of a system architecture and data processing device that may be used to implement one or more illustrative aspects of the concepts described herein in a standalone and/or networked environment. Various network node devices 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topologies and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components and devices which make up the system of FIG. 1 may include data server 103, web server 105, and client computers 107, 109. Data server 103 provides overall access, control and administration of databases and control software for performing one or more illustrative aspects of the concepts described herein. Data server 103 may be connected to web server 105 through which users interact with and obtain data as requested. Alternatively, data server 103 may act as a web server itself and be directly connected to the Internet. Data server 103 may be connected to web server 105 through local area network 133, wide area network 101 (e.g., the Internet), via direct or indirect connection, or via some other network. Users may interact with data server 103 using remote computers 107, 109, e.g., using a web browser to connect to data server 103 via one or more externally exposed web sites hosted by web server 105. Client computers 107, 109 may be used in concert with data server 103 to access data stored therein or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used in the system architecture and data processing device of FIG. 1, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of data server 103. Data server 103 may further include random access memory (RAM) 113, read only memory (ROM) 115, a network interface 117, input/output interfaces 119 (e.g., keyboard, mouse, display, printer, etc.), and memory 121. Input/output (I/O) interfaces 119 may include a variety of interface units and drives for reading, writing, displaying, and/or printing data or files. Memory 121 may store operating system software 123 for controlling overall operation of the data server 103, control logic 125 for instructing data server 103 to perform aspects of the concepts described herein, and other application software 127 providing secondary, support, and/or other functionality which may or might not be used in conjunction with aspects of the concepts described herein. Control logic 125 may also be referred to herein as the data server software. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects of the concepts described herein. Memory 121 may include, for example, a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, and 109 may have similar or different architecture as described with respect to data server 103. Those of skill in the art will appreciate that the functionality of data server 103 (or device 105, 107, or 109) as described herein may be spread across multiple data processing devices, for example, to distribute processing load across multiple computers, to segregate transactions based on geographic location, user access level, quality of service (QoS), etc.

One or more aspects of the concepts described here may be embodied as computer-usable or readable data and/or as computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution or may be written in a scripting language such as (but not limited to) Hypertext Markup Language (HTML) or Extensible Markup Language (XML). The computer executable instructions may be stored on a computer readable storage medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source node and a destination node (e.g., the source node can be a storage or processing node having information stored therein which information can be transferred to another node referred to as a “destination node”). The media can be transferred in the form of electromagnetic waves traveling through signal-conducting media such as metal wires, optical fibers, and/or wireless transmission media (e.g., air and/or space). Various aspects of the concepts described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects of the concepts described herein, and such data structures are contemplated within the scope of computer executable instructions and computer-usable data described herein.

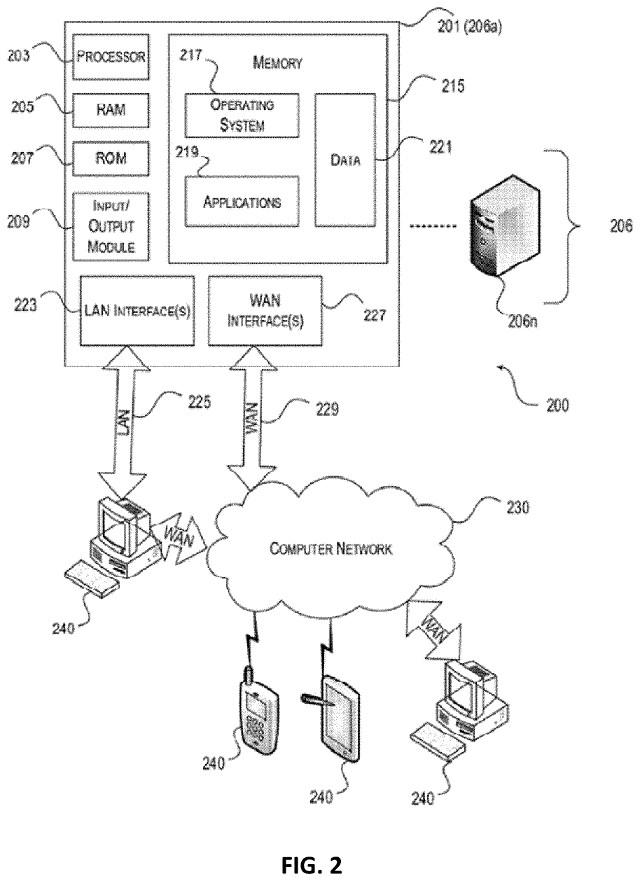

With further reference to FIG. 2, one or more aspects of the concepts described herein may be implemented in a remote-access environment. FIG. 2 depicts an example system architecture including a computing device 201 in an illustrative computing environment 200 that may be used according to one or more illustrative aspects of the concepts described herein. Computing device 201 may be used as a server 206a in a single-server or multi-server desktop virtualization system (e.g., a remote access or cloud system) configured to provide VMs for client access devices. Computing device 201 may have a processor 203 for controlling overall operation of the server and its associated components, including RAM 205, ROM 207, an input/output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by computing device 201, such as an operating system 217, application programs 219, and an associated database 221.

Computing device 201 may operate in a networked environment supporting connections to one or more remote computers, such as terminals 240 (also referred to as client devices). Terminals 240 may be personal computers, mobile devices, laptop computers, tablets, or servers that include many or all the elements described above with respect to data server 103 or computing device 201. The network connections depicted in FIG. 2 include a local area network (LAN) 225 and a wide area network (WAN) 229 but may also include other networks. When used in a LAN networking environment, computing device 201 may be connected to LAN 225 through an adapter or network interface 223. When used in a WAN networking environment, computing device 201 may include a modem or other wide area network interface 227 for establishing communications over WAN 229, such as to computer network 230 (e.g., the Internet). It will be appreciated that the network connections shown are illustrative and other means of establishing a communication link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects of the concepts described herein may also be operational with numerous other general purpose or special purpose computing system environments or configurations. Examples of other computing systems, environments, and/or configurations that may be suitable for use with aspects of the concepts described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more terminals 240 may be in communication with one or more servers 206a-206n (generally referred to herein as “server(s) 206”). In one embodiment, computing environment 200 may include a network appliance installed between server(s) 206 and terminals 240. The network appliance may manage client/server connections, and in some cases can load balance client connections amongst a plurality of back-end servers 206.

Terminals 240 may in some embodiments be referred to as a single computing device or a single group of client computing devices, while server(s) 206 may be referred to as a single server 206 or a group of servers 206. In one embodiment, a single terminal 240 communicates with more than one server 206, while in another embodiment a single server 206 communicates with more than one terminal 240. In yet another embodiment, a single terminal 240 communicates with a single server 206.

Terminal 240 can, in some embodiments, be referred to as any one of the following non-exhaustive terms: client machine(s); client(s); client computer(s); client device(s); client computing device(s); local machine; remote machine; client node(s); endpoint(s); or endpoint node(s). Server 206, in some embodiments, may be referred to as any one of the following non-exhaustive terms: server(s), local machine; remote machine; server farm(s), or host computing device(s).

In one embodiment, terminal 240 may be a VM. The VM may be any VM, while in some embodiments the VM may be any VM managed by a Type 1 or Type 2 hypervisor, for example, a hypervisor developed by Citrix Systems, IBM, VMware, or any other hypervisor. In some aspects, the VM may be managed by a hypervisor, while in other aspects the VM may be managed by a hypervisor executing on server 206 or a hypervisor executing on terminal 240.

Some embodiments include a terminal 240 that displays application output generated by an application remotely executing on server 206 or other remotely located machine. In these embodiments, terminal 240 may execute a VM receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

Server 206, in some embodiments, uses a remote presentation protocol or other program to send data to a thin-client or remote-display application executing on the client to present display output generated by an application executing on server 206. The thin-client or remote-display protocol can be any one of the following non-exhaustive list of protocols: the Independent Computing Architecture (ICA) protocol developed by Citrix Systems, Inc. of Fort Lauderdale, Fla.; or the Remote Desktop Protocol (RDP) manufactured by Microsoft Corporation of Redmond, Wash.

A remote computing environment may include more than one server 206a-206n logically grouped together into a server farm 206, for example, in a cloud computing environment. Server farm 206 may include servers 206a-206n that are geographically dispersed while logically grouped together, or servers 206a-206n that are located proximate to each other while logically grouped together. Geographically dispersed servers 206a-206n within server farm 206 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments, server farm 206 may be administered as a single entity, while in other embodiments server farm 206 can include multiple server farms.

In some embodiments, server farm 206 may include servers that execute a substantially similar type of operating system platform (e.g., WINDOWS, UNIX, LINUX, iOS, ANDROID, SYMBIAN, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server, a master application server, a server executing an active directory, or a server executing an application acceleration program that provides firewall functionality, application functionality, or load balancing functionality. Other server types may also be used.

Some embodiments include a first server 206a that receives requests from terminal 240, forwards the request to a second server 206b (not shown), and responds to the request generated by terminal 240 with a response from second server 206b (not shown). First server 206a may acquire an enumeration of applications available to terminal 240 as well as address information associated with an application server 206 hosting an application identified within the enumeration of applications. First server 206a can present a response to the client's request using a web interface and communicate directly with terminal 240 to provide terminal 240 with access to an identified application. One or more terminals 240 and/or one or more servers 206 may transmit data over network 230, e.g., network 101.

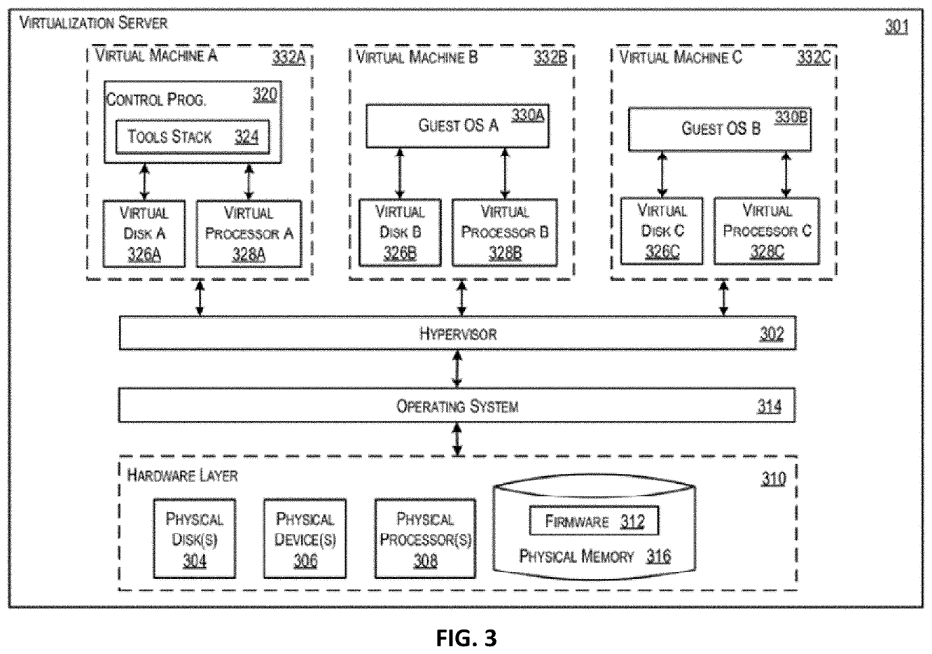

FIG. 3 shows a high-level architecture of an illustrative application virtualization system. As shown, the application virtualization system may be single-server or multi-server system, or cloud system, including at least one virtualization server 301 configured to provide virtual desktops and/or virtual applications to one or more terminals 240 (FIG. 2). As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an operating system running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of server 206 illustrated in FIG. 2 or by other known computing devices. Included in virtualization server 301 is a hardware layer 310 that can include one or more physical disks 304, one or more physical devices 306, one or more physical processors 308, and one or more physical memories 316. In some embodiments, firmware 312 can be stored within a memory element in physical memory 316 and can be executed by one or more of the physical processors 308. Virtualization server 301 may further include an operating system 314 that may be stored in a memory element in physical memory 316 and executed by one or more of the physical processors 308. Still further, a hypervisor 302 may be stored in a memory element in physical memory 316 and can be executed by one or more of the physical processors 308.

Executing on one or more of the physical processors 308 may be one or more VMs 332A-C (generally 332). Each VM 332 may have a virtual disk 326A-C and a virtual processor 328A-C. In some embodiments, a first VM 332A may execute, using a virtual processor 328A, a control program 320 that includes a tools stack 324. Control program 320 may be referred to as a control VM, Dom0, Domain 0, or other VM used for system administration and/or control. In some embodiments, one or more VMs 332B-C can execute, using a virtual processor 328B-C, a guest operating system 330A-B.

Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in hardware layer 310 may include any type of memory. Physical memory 316 may store data, and in some embodiments may store one or more programs, or set of executable instructions. FIG. 3 illustrates an embodiment where firmware 312 is stored within physical memory 316 of virtualization server 301. Programs or executable instructions stored in physical memory 316 can be executed by the one or more processors 308 of virtualization server 301.

In some embodiments, hypervisor 302 may be a program executed by processors 308 on virtualization server 301 to create and manage any number of VMs 332. Hypervisor 302 may be referred to as a VM monitor, or platform virtualization software. In some embodiments, hypervisor 302 can be any combination of executable instructions and hardware that monitors VMs executing on a computing machine. Hypervisor 302 may be a Type 2 hypervisor, where the hypervisor executes within an operating system 314 executing on virtualization server 301. VMs may execute at a level above the hypervisor. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on virtualization server 301 by directly accessing the hardware and resources within hardware layer 310. That is, while a Type 2 hypervisor 302 accesses system resources through host operating system 314, as shown, a Type 1 hypervisor may directly access all system resources without host operating system 314. A Type 1 hypervisor may execute directly on one or more physical processors 308 of virtualization server 301 and may include program data stored in physical memory 316.

Hypervisor 302, in some embodiments, can provide virtual resources to operating systems 330 or control programs 320 executing on VMs 332 in any manner that simulates the operating systems 330 or control programs 320 having direct access to system resources. System resources can include, but are not limited to, physical devices 306, physical disks 304, physical processors 308, physical memory 316, and any other component included in virtualization server 301 hardware layer 310. Hypervisor 302 may be used to emulate virtual hardware, partition physical hardware, virtualize physical hardware, and/or execute VMs that provide access to computing environments. In still other embodiments, hypervisor 302 may control processor scheduling and memory partitioning for a VM 332 executing on virtualization server 301. In some embodiments, virtualization server 301 may execute hypervisor 302 that creates a VM platform on which guest operating systems may execute. In these embodiments, the virtualization server 301 may be referred to as a host server. An example of such a virtualization server is the Citrix Hypervisor provided by Citrix Systems, Inc., of Fort Lauderdale, Fla.

Hypervisor 302 may create one or more VMs 332B-C (generally 332) in which guest operating systems 330 execute. In some embodiments, hypervisor 302 may load a VM image to create VM 332. In other embodiments, hypervisor 302 may execute a guest operating system 330 within VM 332. In still other embodiments, VM 332 may execute guest operating system 330.

In addition to creating VMs 332, hypervisor 302 may control the execution of at least one VM 332. In other embodiments, hypervisor 302 may present at least one VM 332 with an abstraction of at least one hardware resource provided by virtualization server 301 (e.g., any hardware resource available within hardware layer 310). In other embodiments, hypervisor 302 may control the way VMs 332 access physical processors 308 available in virtualization server 301. Controlling access to physical processors 308 may include determining whether a VM 332 should have access to a processor 308, and how physical processor capabilities are presented to VM 332.

As shown in FIG. 3, virtualization server 301 may host or execute one or more VMs 332. A VM 332 is a set of executable instructions that, when executed by processor 308, may imitate the operation of a physical computer such that VM 332 can execute programs and processes much like a physical computing device. While FIG. 3 illustrates an embodiment where virtualization server 301 hosts three VMs 332, in other embodiments virtualization server 301 can host any number of VMs 332. Hypervisor 302, in some embodiments, may provide each VM 332 with a unique virtual view of the physical hardware, memory, processor, and other system resources available to that VM 332. In some embodiments, the unique virtual view can be based on one or more of VM permissions, application of a policy engine to one or more VM identifiers, a user accessing a VM, the applications executing on a VM, networks accessed by a VM, or any other desired criteria. For instance, hypervisor 302 may create one or more unsecure VMs 332 and one or more secure VMs 332. Unsecure VMs 332 may be prevented from accessing resources, hardware, memory locations, and programs that secure VMs 332 may be permitted to access. In other embodiments, hypervisor 302 may provide each VM 332 with a substantially similar virtual view of the physical hardware, memory, processor, and other system resources available to VMs 332.

Each VM 332 may include a virtual disk 326A-C (generally 326) and a virtual processor 328A-C (generally 328.) Virtual disk 326, in some embodiments, is a virtualized view of one or more physical disks 304 of virtualization server 301, or a portion of one or more physical disks 304 of virtualization server 301. The virtualized view of physical disks 304 can be generated, provided, and managed by hypervisor 302. In some embodiments, hypervisor 302 provides each VM 332 with a unique view of physical disks 304. Thus, in these embodiments, the particular virtual disk 326 included in each VM 332 can be unique when compared with the other virtual disks 326.

Virtual processor 328 can be a virtualized view of one or more physical processors 308 of virtualization server 301. In some embodiments, the virtualized view of physical processors 308 can be generated, provided, and managed by hypervisor 302. In some embodiments, virtual processor 328 has substantially all the same characteristics of at least one physical processor 308. In other embodiments, virtual processor 328 provides a modified view of physical processors 308 such that at least some of the characteristics of virtual processor 328 are different than the characteristics of the corresponding physical processor 308.

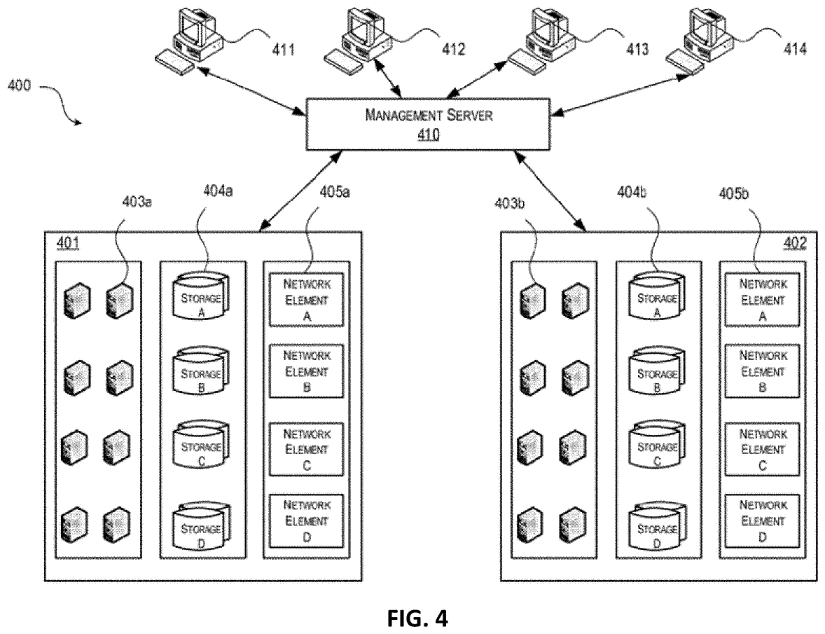

With further reference to FIG. 4, some aspects of the concepts described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred to herein as “host servers 403”), storage resources 404a-404b (generally referred to herein as “storage resources 404”), and network resources 405a-405b (generally referred to herein as “network resources 405”)) of the cloud system.

Management server 410 may be implemented on one or more physical servers. The management server 410 may include, for example, a cloud computing platform or solution, such as APACHE CLOUDSTACK by Apache Software Foundation of Wakefield, Mass., among others. Management server 410 may manage various computing resources, including cloud hardware and software resources, for example, host servers 403, storage resources 404, and network resources 405. The cloud hardware and software resources may include private and/or public components. For example, a cloud environment may be configured as a private cloud environment to be used by one or more customers or client computers 411-414 and/or over a private network. In other embodiments, public cloud environments or hybrid public-private cloud environments may be used by other customers over an open or hybrid networks.

Management server 410 may be configured to provide user interfaces through which cloud operators and cloud customers may interact with the cloud system 400. For example, management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. Management server 410 also may include a set of APIs and/or one or more customer console applications with user interfaces configured to receive cloud computing requests from end users via client computers 411-414, for example, requests to create, modify, or destroy VMs within the cloud environment. Client computers 411-414 may connect to management server 410 via the Internet or some other communication network and may request access to one or more of the computing resources managed by management server 410. In response to client requests, management server 410 may include a resource manager configured to select and provision physical resources in the hardware layer of the cloud system based on the client requests. For example, management server 410 and additional components of the cloud system may be configured to provision, create, and manage VMs and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain client computers 411-414 may be related, for example, different client computers creating VMs on behalf of the same end user, or different users affiliated with the same company or organization. In other examples, certain client computers 411-414 may be unrelated, such as users affiliated with different companies or organizations. For unrelated clients, information on the VMs or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud computing resources. For example, zone 401 may be a first cloud datacenter located in California and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud environment (e.g., client computers 411-414) might or might not be aware of the distinctions between zones. For example, an end user may request the creation of a VM having a specified amount of memory, processing power, and network capabilities. Management server 410 may respond to the user's request and may allocate resources to create the VM without the user knowing whether the VM was created using resources from zone 401 or zone 402. In other examples, the cloud system may allow end users to request that VMs (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more host servers 403, such as the virtualization servers 301 (FIG. 3), which may be configured to create and host VM instances. The physical network resources in cloud zone 401 or 402 may include one or more network resources 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in cloud zone 401-402 may include storage disks (e.g., solid state drives (SSDs), magnetic hard disks, etc.) and other storage devices.

The example cloud computing environment 400 shown in FIG. 4 also may include a virtualization layer (e.g., as shown in FIGS. 1-3) with additional hardware and/or software resources configured to create and manage VMs and provide other services to customers using the physical resources in the cloud environment. The virtualization layer may include hypervisors, as described above in connection with FIG. 3, along with other components to provide network virtualizations, storage virtualizations, etc. The virtualization layer may be as a separate layer from the physical resource layer or may share some or all the same hardware and/or software resources with the physical resource layer. For example, the virtualization layer may include a hypervisor installed in each of the host servers 403 with the physical computing resources. Known cloud systems may alternatively be used, e.g., WINDOWS AZURE (Microsoft Corporation of Redmond, Wash.), AMAZON EC2 (Amazon.com Inc. of Seattle, Wash.), IBM BLUE CLOUD (IBM Corporation of Armonk, N.Y.), or others.

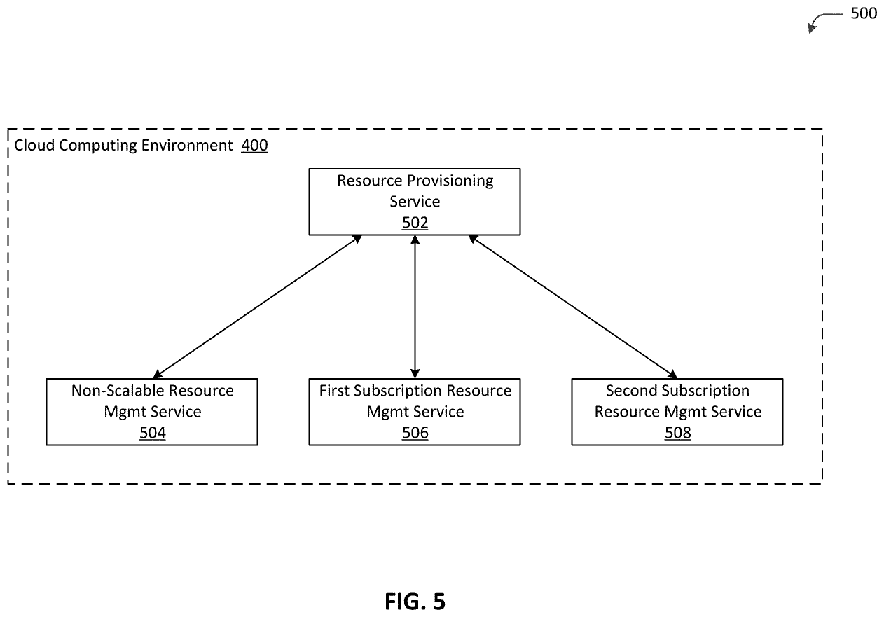

FIG. 5 is a block diagram of an illustrative system architecture 500 including a resource provisioning service 502 deployed in cloud computing environment 400, in accordance with an embodiment of the present disclosure. In accordance with the various embodiments disclosed herein, resource provisioning service 502 may be implemented by an organization to provision various computing resources in a cloud computing environment, such as cloud computing environment 400. For example, resource provisioning service 502 may be deployed in the organization's data center. In some embodiments, resource provisioning service 502 may be the same or similar to the resource manager of management server 410 of FIG. 4.

Architecture 500 also includes a non-scalable resource management service 504, which may be implemented on one or more physical servers and provide management of non-scalable resources that are provided to service requests. For example, the organization may provide a specific number of its own non-scalable resources (e.g., on-premise resources) to service requests. Architecture 500 also includes one or more scalable resource management services, such as a first subscription resource management service 506 and a second subscription resource management service 508, which may be implemented on one or more physical services. First subscription resource management service 506 and second subscription resource management service 508 may provide management of scalable resources that are provided to service requests. For example, the organization may procure (e.g., rent) the scalable resources form a cloud vendor (e.g., a third party provider) under two subscriptions, a first subscription and a second subscription. The subscriptions may specify different fee structures and service level agreements (SLAs) for the resources that are provisioned (i.e., utilized) under the respective subscriptions. Here, first subscription resource management service 506 can provide management of the first subscription scalable resources (i.e., the scalable resources allocated under the first subscription) and second subscription resource management service 508 can provide management of the second subscription scalable resources (i.e., the scalable resources allocated under the second subscription). Although FIG. 5 shows two subscription resource management services 506, 508, it will be understood that there may be a different number of subsequent resource management services, for example, depending on the number of subscriptions under which the scalable resources are being provided. Also, although FIG. 5 shows a non-scalable resource management service 504, it will be understood that architecture 500 may not include non-scalable resource management service 504, for example, in cases where non-scalable resources are not provided to service requests.

It is appreciated herein that provisioning cloud resources to satisfy certain performance criteria (e.g., support of large amounts of concurrent operations, provide good user experience, and low latency) in a cost effective manner is often the goal of organizations that provide such computing resources. These cloud resources (sometimes referred to herein more simply as “resources” or a “resource” in the singular) may refer to any unit of compute resource such as a container (e.g., a stateless container), a VM, a micro VM, or any other infrastructure resource (e.g., virtual clusters, virtual resource pools, physical servers) that provide processing capabilities in the cloud, and combinations thereof. However, achieving this goal may be very difficult and, in some case, impracticable for these organizations. For example, an organization can invest capital in always having a sufficient number of on-premise resource instances started and available for servicing the large amounts of concurrent requests that may be received at any time. While this may allow an organization to achieve good user experience and low latency, this is not very cost effective to the organization. In addition, these on-premise resources are typically not scalable and thus unable to be adjusted (e.g., scaled up or scaled down) to provide any cost savings.

In an attempt to reduce the capital expenditures associated with such non-scalable resources, the organization can procure usage of resources (e.g., scalable resources) from a cloud vendor (e.g., a third party provider). Third party providers typically offer various subscriptions under which an organization can provision one or more scalable resources. For example, the organization may provision the third party provider's scalable resources under two subscriptions, e.g., a consumption plan and a premium plan. Here, the consumption plan may offer an initial number (e.g., 1,000, 10,000, etc.) of free pre-warmed resource instances and charge a set fee for any additional pre-warmed resource instances that are started under the consumption plan by the organization. The premium plan may offer a small number (e.g., one, two, or three) of resource instances that are started and always available to service requests and charge a set fee for additional pre-warmed resource instances that are started under the premium plan by the organization. Since the premium plan includes the resource instances that are always available, the premium plan can be more expensive than the consumption plan. For the resource instances provisioned under these subscriptions, the third party provider may maintain the now provisioned resource instance for a predetermined period of time (e.g., 5 minutes, 10 minutes, or 15 minutes) even after servicing of a request. In other words, even after servicing a request (e.g., executing a function or code), the third party provider may maintain the pre-warmed resource instance to service subsequent requests. In any case, the organization may still not be able to achieve low latency, especially during burst times, since these scalable resources may be started up one at a time, in some cases. In addition, to meet a desired performance goal, the organization may over provision the scalable resources, which results in increased subscription costs to the organization.

Issues with latency are amplified even more in cases of multi-tenant environments where the third party provider's scalable resources can be allocated to multiple customers. Here, each customer may be issuing instructions to start up or shut down thousands of scalable resource instances and, during these times, it may take longer to execute these instructions. To reduce execution times, organizations may use serverless functions to start up or shut down the scalable resource instances. Serverless functions are maintained in the cloud infrastructure and event triggered, meaning that the function code is invoked only when triggered by a request. However, even with serverless functions, the organization may be faced with the cold start problem since pre-warmed scalable resource instances may be shut down after a period of idle time and there may be latency in starting up the necessary scalable resource instances to service subsequent requests.

To address such problems and to provision cloud resources to satisfy specified performance criteria in a cost effective manner, in some embodiments, resource provisioning service 502 is configured to provision scalable resource instances based on a prediction of a number (amount) of requests that are expected and a time at which these requests are expected to be received. In one such embodiment, the prediction of the number of expected requests and the time at which the expected requests are to be received may be made based on historical request data (e.g., information collected regarding historical demand for resources). Based on this prediction, resource provisioning service 502 can determine a number (amount) of resource instances that need to be provisioned (the number of resource instances needed) to service the expected requests and provision a specified number of resource instances to service the expected requests. In some embodiments, resource provisioning service 502 can provision the specified number of resources instances sufficiently prior to the time the requests are expected to be received so that that the provisioned resource instances are available (e.g., pre-warmed) to service the expected number of requests when received. Provisioning the resource instances in this way ensures that the specified number of resource instances is started and available while avoiding the cold start problem.

For example, the organization may predict from historical request data that a specific number of requests, e.g., R, is expected to be received at 8:00 AM on Mondays through Fridays. Upon receiving or otherwise being provided this prediction, resource provisioning service 502 can determine that a specific number of resource instances need to be provisioned to service the R requests expected to be received at 8:00 AM on Mondays through Fridays. Based on this determination, resource provisioning service 502 can provision a specified number of scalable resource instances prior to 8:00 AM on Mondays through Fridays such that the provisioned scalable resource instances (i.e., the pre-warmed scalable resources) are available to service requests at 8:00 AM. For example, suppose a resource instance is capable of servicing one request. In this example case, resource provisioning service 502 can determine that R resource instances will be needed to service the R expected requests and provision R scalable resource instances prior to 8:00 AM on Mondays through Fridays such that the R provisioned scalable resource instances are available to service requests at 8:00 AM. If, however, a resource instance is capable of servicing two requests, resource provisioning service 502 can determine that R/2 resource instances will be needed to service the R expected requests and provision R/2 scalable resource instances prior to 8:00 AM on Mondays through Fridays such that the R/2 provisioned scalable resource instances are available to service requests at 8:00 AM.

Resource provisioning service 502 may periodically receive or otherwise be provided information regarding the number of resource instances that are already started (e.g., brought up) and available to service requests. In some embodiments, the organization may provide a specific number of its own non-scalable resources (e.g., on-premise resources) for servicing requests. In such embodiments, resource provisioning service 502 can periodically send a request for the number of non-scalable resource instances that are already started and available to service requests to non-scalable resource management service 504. In response, resource provisioning service 502 can receive from non-scalable resource management service 504 information regarding the number of non-scalable resource instances that are already started and available to service requests. The information received from non-scalable resource management service 504 can vary depending on the actual number of non-scalable resource instances that are available to service requests at that particular time. This information allows resource provisioning service 502 to take into consideration the number of non-scalable resource instances that are already started and available to service requests when determining the number of resources that need to be provisioned to service the expected number of requests.

Additionally or alternatively, the organization may also procure scalable resources form a third-party provider under various subscriptions, such as, for example, a first subscription and a second subscription. In such cases, resource provisioning service 502 can periodically send a request for the number of scalable resource instances that are already started and available to service requests to first subscription resource management service 506 and second subscription resource management service 508. In response, resource provisioning service 502 can receive from first subscription resource management service 506 information regarding the number of scalable resource instances that are already started and available to service requests under the first subscription (i.e., scalable resources allocated under the first subscription). These scalable resource instances include any pre-warmed resource instances and any resource instances that are always available under the SLA of the first subscription. Similarly, resource provisioning service 502 can receive from second subscription resource management service 508 information regarding the number of scalable resource instances that are already started and available to service requests under the second subscription (i.e., the available resources allocated under the second subscription). These scalable resource instances include any pre-warmed resource instances and any resource instances that are always available under the SLA of the second subscription. The information received from first subscription resource management service 506 and second subscription resource management service 508 can vary depending on the actual number of scalable resource instances that are available to service requests at that particular time. This information allows resource provisioning service 502 to take into consideration the number of scalable resource instances that are already started and available to service requests when determining the number of resources that need to be provisioned to service the expected number of requests.

Resource provisioning service 502 is configured to determine a number of scalable resource instances that need to be provisioned to service a predicted expected number of requests. Resource provisioning service 502 can account for the number of non-scalable resource instances that are already started and available to service requests in determining the number of scalable resource instances that need to be provisioned to service the expected number of requests. Resource provisioning service 502 can also account for the number of scalable resource instances that are already started and available to service requests in determining the number of scalable resource instances that need to be provisioned to service the expected number of requests. For example, suppose 5,000 requests are expected and that one resource instance is capable of servicing one request. Also suppose that information from the resource management services indicates that there are 500 non-scalable resource instances and 500 scalable resource instances already started and available to service requests. Based on this information, resource provisioning service 502 can determine that 4,000 (i.e., 5,000−500−500=4,000) scalable resource instances need to be provisioned in addition to the resource instances that are already started and available to service the expected 5,000 requests.

Upon determining the number of scalable resource instances that need to be provisioned, resource provisioning service 502 can send respective requests to first subscription resource management service 506 and second subscription management service 508 to provision the needed number of scalable resource instances. In some embodiments, resource provisioning service 502 can distribute the needed number of scalable resource instances between the various available subscriptions to minimize subscription costs (e.g., the total fees paid for the scalable resource instances provisioned under the different subscriptions). This can be accomplished, for example, by considering the number of scalable resource instances already started and available to service requests under the available subscriptions and the terms of the SLAs of the available subscriptions, such as, for example, number of free pre-warmed resource instances, number of resource instances always available to service requests, maximum number of resource instances that can be provisioned, and fees charged for the resource instances. Continuing the above example, resource provisioning service 502 can determine that provisioning 3,000 scalable resource instances under the first subscription and 1,000 scalable resource instances under the second subscription will minimize the subscription costs. To provision the 4,000 scalable resource instances under this distribution, resource provisioning service 502 can send a request to first subscription resource management service 506 to provision 3,000 scalable resource instances under the first subscription and a request to second subscription resource management service 508 to provision 1,000 scalable resource instances under the second subscription.

Responsive to a request to provision a specified number of scalable resource instances, the scalable resource management service (e.g., first subscription management service 506 and second subscription management service 508) can start up the specified number of scalable resource instances. In some embodiments, the scalable resource management service can start a scalable resource instance by initiating execution of a startup function that is configured to consume the one or more processors of the started scalable resource instance for a predetermined duration, e.g., N seconds. In other words, the started scalable resource instance is consumed with servicing the executing startup function for the predetermined duration and not available for (capable of) servicing any other request (e.g., other function or code) during the predetermined duration. The started scalable resource instance is available to service (e.g., process) a request or requests subsequent to the predetermined duration since, as previously described, the now provisioned scalable resource instance is maintained fora period of time (e.g., 5 minutes, 10 minutes, or 15 minutes) even after servicing the startup function. However, during the predetermined duration where the scalable resource instance is consumed servicing the startup function, if another request is sent to the scalable resource management service for servicing, the scalable resource management service will start another (i.e., a second) scalable resource instance to service this other request. Use of this startup function allows the scalable resource management service to start up multiple scalable resource instances in parallel and have the multiple scalable resource instances available to service requests. For example, responsive to a request to provision 1,000 scalable resource instances, first subscription management service 506 can initiate execution of the startup function 1,000 times to start up 1,000 scalable resource instances under the first subscription and have the pre-warmed 1,000 scalable resource instances available to service requests. In a similar manner, responsive to a request to provision, for example, 1,500 scalable resource instances, second subscription management service 508 can initiate execution of the startup function 1,500 times to start up 1,500 scalable resource instances under the second subscription and have the pre-warmed 1,500 scalable resource instances available to service requests.

In some embodiments, resource provisioning service 502 can send or otherwise provide the startup function to use in starting a scalable resource instance to the scalable resource management service (e.g., first subscription management service 506 and second subscription management service 508). For example, resource provisioning service 502 can send the startup function with a request to provision a specified number of scalable resource instances. This allows resource provisioning service 502 to manage a single or common startup function for use by the different scalable resource management services. In such embodiments, resource provisioning service 502 can appropriately configure the startup function to consume the started scalable resource instance based on the resource that is being provisioned. For example, if the scalable resource that is being provisioned is CPU, the startup function can be configured to consume the CPU so that the started scalable resource instance (i.e., the CPU) is not available for servicing a request for the predetermined duration. As another example, if the resource that is being provisioned is 4 GB RAM, the startup function can be configured to consume 4 GB of memory so that the started scalable resource instance (i.e., the 4 GB RAM) is not available for servicing a request for the predetermined duration. As another example, if the resource that is being provisioned is 8 GB RAM, the startup function can be configured to consume 8 GB of memory so that the started scalable resource instance (i.e., the 8 GB RAM) is not available for servicing a request for the predetermined duration. It will be appreciated that certain resources (e.g., a VM) can include one or more computing resources, such as, by way of example, CPU, memory, storage, etc. For such resources, the startup function can be configured to consume one or more of the resources that are included in such resource. In any case, in order to configure the startup function to consume the appropriate resource, in one embodiment, resource provisioning service 502 can query the appropriate scalable resource management service for information regarding the scalable resource that is to be provisioned.

In some embodiments, the startup function used to start a scalable resource instance may be implemented as a serverless function (e.g., as a serverless startup function). In serverless computing, functions can be run in stateless compute containers that can be event triggered, meaning the function code is invoked only when triggered by a request. Developers can create the function and then rely on a cloud provider to allocate the needed resources (e.g., compute resources and storage) to execute the function. Thus, first subscription management service 506 can upload the serverless startup function to a provider (e.g., one of its own scalable resources). Then, to start up a specified number of scalable resource instances, first subscription management service 506 can send an appropriate number of requests to invoke the serverless startup function the specified number of times. In an analogous manner, second subscription management service 508 can upload the serverless startup function to a provider (e.g., one of its own scalable resources). Then, to start up a specified number of scalable resource instances, second subscription management service 508 can send an appropriate number of requests to invoke the serverless startup function the specified number of times.

In some embodiments, resource provisioning service 502 can receive information from the scalable resource management service (e.g., first subscription management service 506 or second subscription management service 508) that allows resource provisioning service 502 to provision (scale out) the needed scalable resource instances in a just-in-time (JIT) manner to minimize (and ideally eliminate) the cold start problem as well as the time a started scalable resource instance is idle after being started. For example, according to one embodiment, first subscription management service 506 can maintain records of historical cold start times needed to start up the scalable resource instances under the first subscription. The recorded cold start time is the duration from when the function is initiated to start up a scalable resource instance to when the started scalable resource instance is available to service a request. As such, the cold start time includes the predetermined duration (e.g., N seconds) the executing startup function consumes the started scalable resource instance. First subscription management service 506 can then send or otherwise provide the recorded historical cold start times to resource provisioning service 502. Similarly, second subscription management service 508 can maintain records of historical cold start times needed to start up the scalable resource instances under the second subscription and send or otherwise provide the recorded historical cold start times to resource provisioning service 502. In one embodiment, resource provisioning service 502 can query the subscription management services (e.g., first subscription management service 506 and second subscription management service 508) for the historical cold start times, for example, by calling a cloud provider API.

Resource provisioning service 502 can then use this information from the scalable resource management service(s) to determine an appropriate time to send requests to provision the scalable resource instances in a JIT manner. For example, according to one embodiment, resource provisioning service 502 can determine an average cold start time, e.g., T, from the historical cold start times needed to start up a scalable resource instance under the first subscription. Resource provisioning service 502 can then send a request to first subscription resource management service 506 to provision a specified number of scalable resource instances at a time that is the average cold start time, T, prior to the time the specified number of provisioned scalable resource instances under the first subscription are needed. For example, suppose that the historical cold start times needed to start up a scalable resource instance under the first subscription are 9 seconds, 10 seconds, and 11 seconds. In this example case, resource provisioning service 502 can determine the average cold start time to be 10 seconds (i.e., (9+10+11)/3=10 seconds) and send a request to first subscription resource management service 506 to provision a specified number of scalable resource instances 10 seconds (i.e., T) prior to the time the specified number of provisioned scalable resource instances under the first subscription are needed.

In other embodiments, resource provisioning service 502 can also determine an average deviation, e.g., D, in the historical cold start times needed to start up a scalable resource instance under the first subscription. Resource provisioning service 502 can then send a request to first subscription resource management service 506 to provision a specified number of scalable resource instances at a time that is the average cold start time, T, and the average deviation, D, prior to the time the specified number of provisioned scalable resource instances under the first subscription are needed. Continuing the above example, resource provisioning service 502 can determine the average deviation in the historical cold start times to be 0.67 seconds (i.e., (1+0+1)/3=0.67 seconds) and send a request to first subscription resource management service 506 to provision a specified number of scalable resource instances 10.67 seconds (i.e., T+D) prior to the time the specified number of provisioned scalable resource instances under the first subscription are needed.

Note that resource provisioning service 502 can determine an average cold start time for the scalable resource instances provisioned under the second subscription and send a request to second subscription resource management service 508 to provision a specified number of scalable resource instances based on the average cold start time in a manner similar to that described above with respect to first subscription resource management service 506. Also note that resource provisioning service 502 can also determine an average deviation in the historical cold start times for the scalable resource instances provisioned under the second subscription and send a request to second subscription resource management service 508 to provision a specified number of scalable resource instances based on the average cold start time and the average deviation in a manner similar to that described above with respect to first subscription resource management service 506.

In some embodiments, the scalable resource management service (e.g., first subscription management service 506 or second subscription management service 508) can determine the average cold start time, e.g., T, from the historical cold start times needed to start up a scalable resource instance under the subscription. Then, responsive to a request to provision a specified number of scalable resource instances, the scalable resource management service can initiate execution of the startup function to start up a scalable resource instance the specified number of times (or, in the case of a serverless startup function, send an appropriate number of requests to invoke the serverless startup function the specified number of times) at a time T prior to the time the specified number of provisioned scalable resource instances are needed. Note that in such embodiments, the scalable resource management service may also receive or otherwise be provided the time by which the provisioned scalable resource instances are needed to service requests.

In some embodiments, the scalable resource management service (e.g., first subscription management service 506 or second subscription management service 508) can also determine the average deviation, e.g., D, in the historical cold start times needed to start up a scalable resource instance under the subscription. Then, responsive to a request to provision a specified number of scalable resource instances, the scalable resource management service can initiate execution of the startup function to start up a scalable resource instance the specified number of times (or, in the case of a serverless startup function, send an appropriate number of requests to invoke the serverless startup function the specified number of times) at a time T+D prior to the time the specified number of provisioned scalable resource instances are needed. Note that in such embodiments, the scalable resource management service may also receive or otherwise be provided the time by which the provisioned scalable resource instances are needed to service requests.

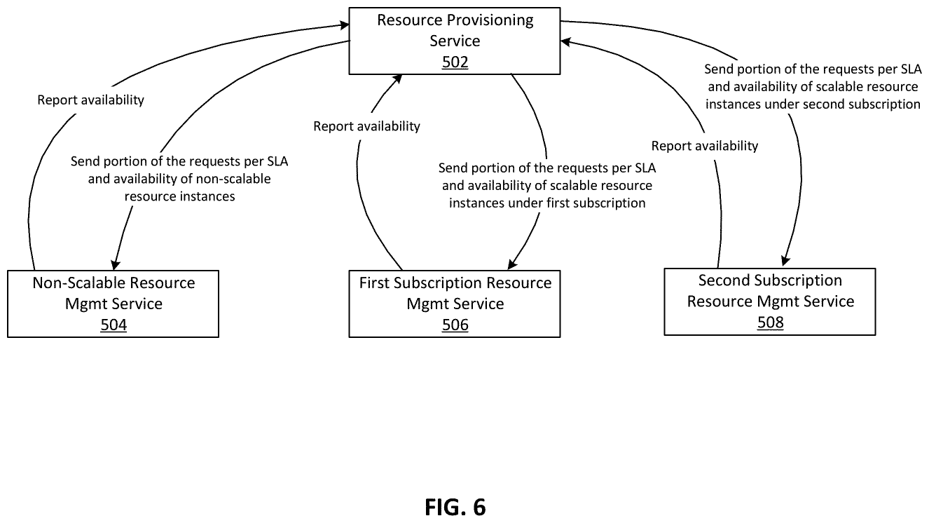

FIG. 6 is a diagram showing an example allocation of requests between resource management services, in accordance with an embodiment of the present disclosure. In the example of FIG. 6, the organization may be providing resources (e.g., non-scalable resources and scalable resources) as a cloud provider to a customer under an SLA entered between the organization and the customer. As explained above, the non-scalable resources may be the organization's own resources. Also note that the organization may itself be procuring (e.g., renting) some or all of the non-scalable resources from a third party provider under, for example, a first subscription and a second subscription. In brief, to provide resources to the customer, the organization may predict a number of requests that are expected to be generated by the customer and a time at which these requests are expected to be generated. This prediction may be based on numbers of requests and the times these requests were received from the customer in the past. Based on this prediction, the organization can determine a number of resource instances that need to be provisioned to service the expected requests from the customer and provision the needed number of resource instances to service the requests that are expected to be received.

In more detail, as shown in FIG. 6, resource provisioning service 502 may periodically receive information regarding the number of resource instances that are already started and available to service requests. For example, non-scalable resource management service 504 can send the information regarding the number of non-scalable resource instances that are available to service requests, first subscription resource management service 506 can send information regarding the number of scalable resource instances that are already started and available to service requests under the first subscription, and second subscription resource management service 508 can send information regarding the number of scalable resource instances that are already started and available to service requests under the second subscription. Based on this information, resource provisioning service 502 can determine the number of additional scalable resource instances that are needed to service the predicted number of requests that are expected to be received from the customer. Resource provisioning service 502 can then, near the time the requests from the customer are expected to be received, provision the needed number of additional scalable resources under the first subscription and/or the second subscription based on the SLA entered between the organization and the third party provider. Then, when the predicted requests are received from the customer, resource provisioning service 502 can allocate these requests to non-scalable resource management service 504, first subscription resource management service 506, and second subscription resource management service 508 for servicing. For example, resource provisioning service 502 can send a portion of the received requests to non-scalable resource management service 504 per the SLA entered between the organization and the customer and the number of non-scalable resources available to service the requests, send a portion of the received requests to scalable resource management service 506 per the SLA and the number of scalable resources provisioned and available under the first subscription between the organization and the third party provider to service the requests, and send the remaining requests to scalable resource management service 508 per the SLA and the number of scalable resources provisioned and available under the second subscription between the organization and the third party provider to service the requests.

In some cases, the predicted number of requests that are expected to be received may be inaccurate. That is, the predicted number of requests that are expected to be received may not be the same as the actual number of requests that are received. For instance, the actual number of requests that are received may be larger than the number that was predicted. In this case, the number of provisioned scalable resource instances under the first subscription and/or the second subscription are insufficient to service the actual number of requests that are being received. In such cases, resource provisioning service 502, according to one embodiment, can provision any additional scalable resources instances that are needed to service the requests that are received beyond the predicted number (i.e., the requests which were not expected or planned for) under the subscription having the smaller average cold start time. In this way, resource provisioning service 502 can provide better user experience and low latency. For example, suppose that 10,000 requests are predicted to be received and, based on this prediction, 6,000 scalable resource instances are provisioned under the first subscription and 4,000 scalable resource instances are provisioned under the second subscription. Also suppose that the first subscription has an average cold start time of 1.2 seconds and the second subscription has an average cold start time of 1 second, and that 11,000 requests are actually received. In this example case, the resource provisioning service can provision the additional 1,000 resource instances needed to service the 1,000 requests that are received beyond the predicted 10,000 requests under the second subscription since the second subscription has a smaller average cold start time.

In some embodiments, resource provisioning service 502 may determine what subscription to use for provisioning the additional scalable resources needed to service the received requests based on a configuration parameter or setting. For example, a user, such as a system administrator, may specify that the subscription providing the best performance (e.g., the subscription having the smallest average cold start time), the best price (e.g., the subscription having the lowest cost), or other condition, is to be used for provisioning any scalable resources that are needed to service the received requests (e.g., the request which were not expected or planned for). Resource provisioning service 502 can then provision any needed scalable resource based on the configuration setting.

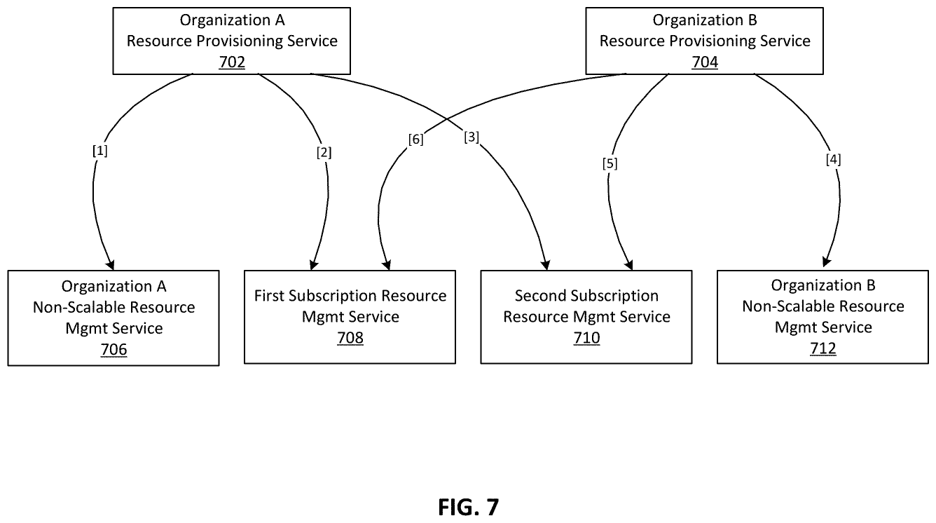

FIG. 7 is a diagram showing an example contextual management of computing resources, in accordance with an embodiment of the present disclosure. In the example of FIG. 7, two organizations, an organization A and an organization B, may be providing resources (e.g., non-scalable resources and scalable resources) as a cloud provider to their customers. As can be seen, organization A may implement a resource provisioning service 702 to provision various computing resources to its customers and organization B may implement a resource provisioning service 704 to provision various computing resources to its customers. In some embodiments, resource provisioning services 702, 704 may be the same or similar to resource provisioning service 502 of FIG. 5. In some embodiments, resource provisioning services 702, 704 may be a single instance of a resource provisioning service that is configured to support multiple tenants and/or multiple customers (e.g., organization A and organization B).

Organization A may provide a specific number of its own non-scalable resources (e.g., on-premise resources) to service requests from its customers. To do so, organization A may implement a non-scalable resource management service 706 which provides management of organization A's non-scalable resources. Similarly, organization B may provide a specific number of its own non-scalable resources (e.g., on-premise resources) to service requests from its customers. To do so, organization B may implement a non-scalable resource management service 712 which provides management of organization B's non-scalable resources. In some embodiments, non-scalable resource management services 706, 712 may be the same or similar to non-scalable resource management service 504 of FIG. 5.

Organization A may be procuring (e.g., renting) the non-scalable resources from a third party provider under, for example, a first subscription and a second subscription. To allow organization A to consume non-scalable resources under the two subscriptions, the third party provider may provide a first subscription resource management service 708 for management of scalable resources under the first subscription and a second subscription resource management service 710 for management of scalable resources under the second subscription. Organization A can then use first subscription resource management service 708 to provision scalable resources under the first subscription and second subscription resource management service 710 to provision scalable resources under the second subscription. Similarly, organization B may also be procuring (e.g., renting) the non-scalable resources from the same third party provider under, for example, the first subscription and the second subscription. Thus, organization B can also use first subscription resource management service 708 to provision scalable resources under the first subscription and second subscription resource management service 710 to provision scalable resources under the second subscription. In some embodiments, subscription resource management services 708, 710 may be the same or similar to subscription resource management services 506, 508 of FIG. 5. Sharing of subscription plans (e.g., sharing of scalable resources) in this manner may allow the third party provider to provide cost savings to subscription participants while also providing the benefits associated with improved cold start times (e.g., low latency).

Still referring to the example of FIG. 7, as can be seen, once the appropriate numbers of scalable resource instances are provisioned under the first and second subscriptions, resource provisioning service 702 can allocate received requests from its customers (i.e., customers of organization A) to non-scalable resource management service 706, first subscription resource management service 708, and second subscription resource management service 710 for servicing. For example, upon receiving the requests from a customer, resource provisioning service 702 can send [1] a portion of the received requests to non-scalable resource management service 706 per an SLA entered between the organization A and the customer, send [2] a portion of the received requests to scalable resource management service 708 per the SLA and the number of scalable resources provisioned and available under the first subscription between organization A and the third party provider to service the requests, and send [3] the remaining requests to scalable resource management service 710 per the SLA and the number of scalable resources provisioned and available under the second subscription between organization A and the third party provider to service the requests. In a similar manner, once the appropriate numbers of scalable resource instances are provisioned under the first and second subscriptions, resource provisioning service 704 can allocate received requests from its customers (i.e., customers of organization B) to non-scalable resource management service 712, first subscription resource management service 708, and second subscription resource management service 710 for servicing. For example, upon receiving the requests from a customer, resource provisioning service 704 can send [4] a portion of the received requests to non-scalable resource management service 712 per an SLA entered between the organization B and the customer, send [6] a portion of the received requests to scalable resource management service 708 per the SLA and the number of scalable resources provisioned and available under the first subscription between organization B and the third party provider to service the requests, and send [5] the remaining requests to scalable resource management service 710 per the SLA and the number of scalable resources provisioned and available under the second subscription between organization B and the third party provider to service the requests.

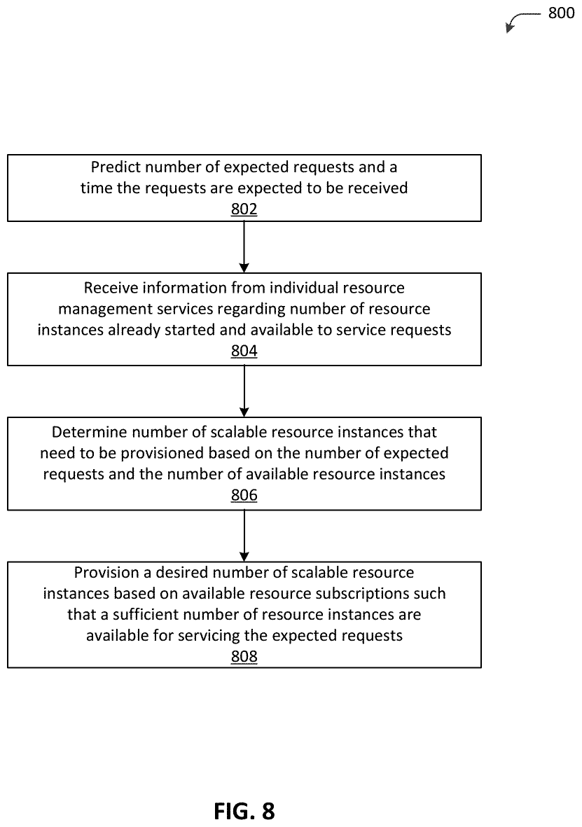

FIG. 8 is a flow diagram of an illustrative process 800 for provisioning scalable resource instances based on a predicted expected number of requests, in accordance with an embodiment of the present disclosure. For example, process 800, and process 900 further described below, can be implemented within a resource provisioning service (e.g., resource provisioning service 502 of FIG. 5) running in a cloud computing environment (e.g., cloud computing environment 400 of FIGS. 4 and 5). In some embodiments, the operations, functions, or actions illustrated in example process 700, and example process 800 further described below, may be stored as computer-executable instructions in a computer-readable medium, such as RAM 113, ROM 115, and/or memory 121 of data server 103 of FIG. 2, RAM 205, ROM 207, and/or memory 215 of computing device 201 of FIG. 2, and/or physical memory 316 of computer device 301 of FIG. 3.

With reference to process 800 of FIG. 8, at 802, the resource provisioning service can predict a number of expected requests and a time the requests are expected to be received. The prediction of the number of expected requests and the time at which the expected requests are to be received may be made based on historical request data (e.g., information collected regarding historical demand for resources). The historical request data can include, for example, types of historical requests, types of resources requested, approximate times the historical requests were received.

At 804, the resource provisioning service can receive information from the individual resource management services regarding the number of resource instances that are already started and available to service requests. For example, if non-scalable resources are being provided to service requests, a non-scalable resource management service managing the non-scalable resources (e.g., non-scalable resource management service 504 of FIG. 5) can send or otherwise provide information regarding the number of non-scalable resource instances available to service requests. Similarly, if scalable resources are being provided under various subscriptions to service requests, the individual subscription resource management services managing the scalable resources under the subscriptions (e.g., first subscription resource management service 506 and second subscription resource management service 508 of FIG. 5) can send or otherwise provide information regarding the number of scalable resource instances that are already started and available to service requests under the respective subscriptions.

At 806, the resource provisioning service can determine a number of scalable resource instances that need to be provisioned based on the number of expected requests and the number of resource instances available to service requests. Here, the number of resource instances available to service requests include the number of non-scalable resource instances available to service requests and the number of scalable resource instances that are already started and available to service requests under the various subscriptions. The number of scalable resource instances that need to be provisioned is the difference between the number of expected requests and the number of resource instances available to service requests. Note that, in some cases (e.g., there are a sufficient number of resource instances available to service the expected number of requests), the resource provisioning service can determine that no additional scalable resource instances need to be provisioned.

At 808, the resource provisioning service can provision a specified number of scalable resource instances based on the available resource subscriptions such that a sufficient number of resource instances are available for servicing the expected number of requests. The sufficient number of resource instances include the non-scalable resource instances that are available to service requests. In some cases, the specified number is the number of additional scalable resource instances that is required to service the expected number of requests. For example, suppose that 7,000 requests are expected to be received and that 1,000 non-scalable resource instances are available to service requests and 2 scalable resource instances are already started and available to service requests. In this example case, the resource provisioning service can provision 5,998 (i.e., 7,000−(1,000+2)=5,998) scalable resource instances. In other cases, the specified number is less than the number of additional scalable resource instances that is required to service the expected number of requests. For example, considering the assumptions of the above example, the resource provisioning service can provision less than 5,998 scalable resource instances. For example, the maximum number of scalable resource instances permitted under the SLAs of the available subscriptions may be less than the number of instances needed (e.g., less than 5,998). As another example, the resource provisioning service may determine that the expected requests will not be received at once but, rather, received over a period of time. In this example case, the resource provisioning service can provision a number of scalable resource instances with the expectation that the provisioned scalable resource instances will be available to service the expected requests that are received later in time.

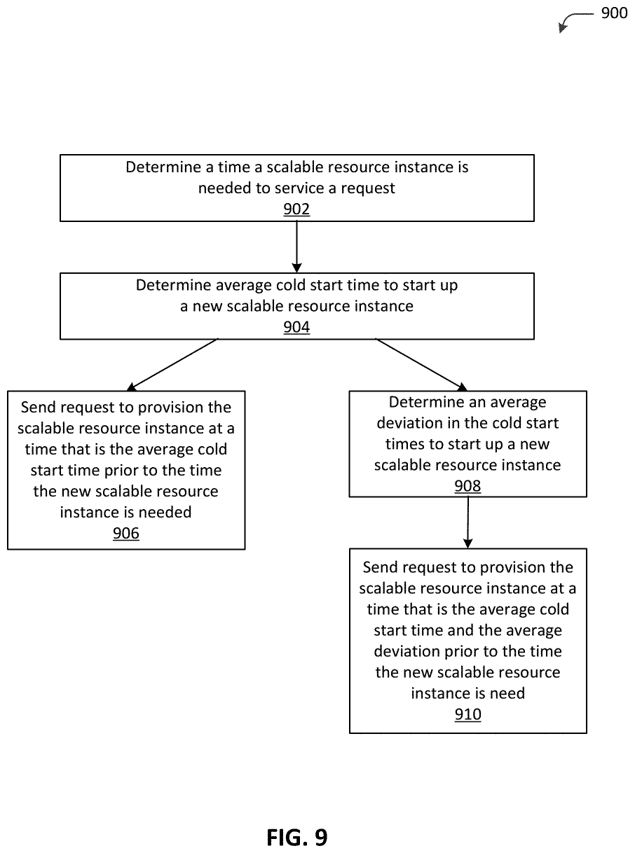

Upon determining the number of scalable resource instances that are to be provisioned, the resource provisioning service can send a request to the individual subscription resource management services (e.g., first subscription resource management service 506 and second subscription resource management service 508 of FIG. 5) to provision a specified number of scalable resource instances under the respective subscriptions. For example, continuing the above example, also suppose that the SLA of the first subscription specifies a maximum of 5,000 scalable resource instances and the SLA of the second subscription specifies an unlimited number of scalable resource instances. Also suppose that the 2 scalable resource instances that are already started and available to service requests are provided under the second subscription and that the resource instances provisioned under the first subscription is less expensive than the resource instances provisioned under the second subscription. In this example case, the resource provisioning service can send a request to first subscription resource management service 506 to start up 5,000 scalable resource instances (the maximum number of scalable resource instances permitted under the first subscription). The resource provisioning service can also send a request to second subscription resource management service 508 to start up the remaining 998 scalable resource instances. In some embodiments, the resource provisioning service can send the request to the individual subscription resource management services to provision the specified number of scalable resource instances in a JIT manner, as previously described herein and as will be further described below with respect to FIG. 9.

FIG. 9 is a flow diagram of an illustrative process 900 for provisioning scalable resource instances in a just-in-time (JIT) manner, in accordance with an embodiment of the present disclosure. At 902, the resource provisioning service can determine a time a scalable resource instance is needed to service a request. The request may be an expected request that is predicted to be received. This determination may be based on a prediction of a time at which the expected request is to be received. These predictions may be based on historical request data (e.g., information collected regarding historical demand for resources).

At 904, the resource provisioning service can determine an average cold start time to start up a new scalable resource instance. The average cold start time can be determined from records of historical cold start times needed to start up the scalable resource instances in the past.

At 906, the resource provisioning service can send a request to provision the scalable resource instance at a time that is the average cold start time prior to the time the new scalable resource instance is needed. For example, suppose a new scalable resource instance is needed at 9:00 AM and that the average cold start time is 20 seconds. In this example case, the resource provisioning service can send a request to a subscription resource management service (e.g., first subscription resource management service 506 or second subscription resource management service 508 of FIG. 5) to provision a specified number of the scalable resource instances at or near 8:59:40 AM.

In some embodiments, at 908, the resource provisioning service can determine an average deviation in the cold start times to start up a new scalable resource instance. At 910, the resource provisioning service can send a request to provision the scalable resource instance at a time that is the average cold start time and the average deviation prior to the time the new scalable resource instance is need. Continuing the above example, also suppose that the average deviation in the cold start times is 1 second. In this example case, the resource provisioning service can send a request to a subscription resource management service (e.g., first subscription resource management service 506 or second subscription resource management service 508 of FIG. 5) to provision a specified number of the scalable resource instances at or near 8:59:39 AM.

### Further Example Embodiments

The following examples pertain to further embodiments, from which numerous permutations and configurations will be apparent.

Example 1 includes a method including: determining, by a computing device, a number of expected requests that cannot be processed using non-scalable resource instances that are available to process requests; and provisioning, by the computing device, one or more scalable resource instances based on the number of expected requests that cannot be processed using the non-scalable resource instances that are available to process requests, the provisioning of the one or more scalable resource instances including executing a startup function configured to consume one or more processors of a started scalable resource instance for a predetermined duration, the started scalable resource instance being available to process a request subsequent to the predetermined duration.

Example 2 includes the subject matter of Example 1, wherein the one or more scalable resource instances are provisioned under a plurality of subscriptions.

Example 3 includes the subject matter of Example 2, wherein the plurality of subscriptions includes a first subscription and a second subscription, the first subscription being less expensive than the second subscription.

Example 4 includes the subject matter of any of Examples 1 through 3, wherein the number of expected requests is based on historical request data.

Example 5 includes the subject matter of any of Examples 1 through 4, wherein provisioning of the one or more scalable resource instances is also based on a number of scalable resource instances started and available to service requests.

Example 6 includes the subject matter of any of Examples 1 through 5, wherein the startup function configured to consume the started scalable resource instance is initiated at a predetermined time prior to a time the scalable resource instance is needed to be available, the predetermined time is based on an average cold start time to provision the scalable resource instance.

Example 7 includes the subject matter of Example 6, wherein the predetermined time is also based on an average deviation historical cold start times to provision the scalable resource instance.

Example 8 includes the subject matter of any of Examples 1 through 7, wherein the one or more scalable resource instances that are provisioned is less than a number of scalable resource instances needed to process the number of expected requests that cannot be processed using non-scalable resource instances.

Example 9 includes the subject matter of any of Examples 1 through 8, wherein the resource instance includes one of a container instance, a virtual machine (VM) instance, or a micro VM instance.

Example 10 includes a system including a memory and one or more processors in communication with the memory and configured to: determine a number of expected requests that cannot be processed using non-scalable resource instances that are available to process requests; and provision one or more scalable resource instances based on the number of expected requests that cannot be processed using the non-scalable resource instances that are available to process requests, the provisioning of the one or more scalable resource instances includes execution a startup function configured to consume one or more processors of a started scalable resource instance for a predetermined duration, the started scalable resource instance being available to process a request subsequent to the predetermined duration.

Example 11 includes the subject matter of Example 10, wherein the one or more scalable resource instances are provisioned under a plurality of subscriptions, the plurality of subscriptions including a first subscription and a second subscription, the first subscription being less expensive that the second subscription.

Example 12 includes the subject matter of Example 11, wherein the plurality of subscriptions includes a first subscription and a second subscription, the first subscription being less expensive than the second subscription.

Example 13 includes the subject matter of any of Examples 10 through 12, wherein the number of expected requests is based on historical request data.

Example 14 includes the subject matter of any of Examples 10 through 13, wherein to provision of the one or more scalable resource instances is also based on a number of scalable resource instances started and available to service requests.

Example 15 includes the subject matter of any of Examples 10 through 14, wherein the startup function configured to consume the started scalable resource instance is initiated at a predetermined time prior to a time the scalable resource instance is needed to be available, the predetermined time is based on an average cold start time to provision the scalable resource instance.

Example 16 includes the subject matter of Examples 15, wherein the predetermined time is also based on an average deviation historical cold start times to provision the scalable resource instance.

Example 17 includes the subject matter of any of Examples 10 through 16, wherein the startup function configured to consume the started scalable resource instance is a serverless startup function.

Example 18 includes a method including: determining, by a computing device, a time a scalable resource instance is needed to service a request; determining, by the computing device, an average cold start time to start up a new scalable resource instance; and sending, by the computing device, a request to provision the scalable resource instance at a time that is the average cold start time prior to the time the new scalable resource instance is needed.

Example 19 includes the subject matter of Example 18, wherein the average cold start time is determined from records of historical cold start times needed to start up the scalable resource instances in the past.

Example 20 includes the subject matter of any of Examples 18 and 19, further including: determining, by the computing device, an average deviation in the cold start times to start up the new scalable resource instance; and sending, by the computing device, the request to provision the scalable resource instance at a time that is the average cold start time and the average deviation prior to the time the new scalable resource instance is need.

Example 21 includes a system including a memory and one or more processors in communication with the memory and configured to: determine a time a scalable resource instance is needed to service a request; determine an average cold start time to start up a new scalable resource instance; and send a request to provision the scalable resource instance at a time that is the average cold start time prior to the time the new scalable resource instance is needed.

Example 22 includes the subject matter of Example 21, wherein the average cold start time is determined from records of historical cold start times needed to start up the scalable resource instances in the past.

Example 23 includes the subject matter of any of Examples 21 and 22, wherein the one or more processors are further configured to: determine an average deviation in the cold start times to start up the new scalable resource instance; and send the request to provision the scalable resource instance at a time that is the average cold start time and the average deviation prior to the time the new scalable resource instance is need.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
determining, by a computing device, a number of expected requests that cannot be processed using non-scalable resource instances that are available to process requests; and
provisioning, by the computing device, one or more scalable resource instances based on the number of expected requests that cannot be processed using the non-scalable resource instances that are available to process requests, the provisioning of the one or more scalable resource instances including executing a startup function configured to consume one or more processors of a started scalable resource instance for a predetermined duration, the started scalable resource instance being available to process a request subsequent to the predetermined duration.

2. The method of claim 1, wherein the one or more scalable resource instances are provisioned under a plurality of subscriptions.

3. The method of claim 2, wherein the plurality of subscriptions includes a first subscription and a second subscription, the first subscription being less expensive than the second subscription.

4. The method of claim 1, wherein the number of expected requests is based on historical request data.

5. The method of claim 1, wherein provisioning of the one or more scalable resource instances is also based on a number of scalable resource instances started and available to service requests.

6. The method of claim 1, wherein the startup function configured to consume the started scalable resource instance is initiated at a predetermined time prior to a time the scalable resource instance is needed to be available, the predetermined time is based on an average cold start time to provision the scalable resource instance.

7. The method of claim 6, wherein the predetermined time is also based on an average deviation historical cold start times to provision the scalable resource instance.

8. The method of claim 1, wherein the one or more scalable resource instances that are provisioned is less than a number of scalable resource instances needed to process the number of expected requests that cannot be processed using non-scalable resource instances.

9. The method of claim 1, wherein the resource instance includes one of a container instance, a virtual machine (VM) instance, or a micro VM instance.

10. A system comprising:
a memory; and
one or more processors in communication with the memory and configured to,
determine a number of expected requests that cannot be processed using non-scalable resource instances that are available to process requests; and
provision one or more scalable resource instances based on the number of expected requests that cannot be processed using the non-scalable resource instances that are available to process requests, the provisioning of the one or more scalable resource instances includes execution a startup function configured to consume one or more processors of a started scalable resource instance for a predetermined duration, the started scalable resource instance being available to process a request subsequent to the predetermined duration.

11. The system of claim 10, wherein the one or more scalable resource instances are provisioned under a plurality of subscriptions.

12. The system of claim 11, wherein the plurality of subscriptions including a first subscription and a second subscription, the first subscription being less expensive that the second subscription.

13. The system of claim 10, wherein the number of expected requests is based on historical request data.

14. The system of claim 10, wherein to provision the one or more scalable resource instances is also based on a number of scalable resource instances started and available to service requests.

15. The system of claim 10, wherein the startup function configured to consume the started scalable resource instance is initiated at a predetermined time prior to a time the scalable resource instance is needed to be available, the predetermined time is based on an average cold start time to provision the scalable resource instance.

16. The system of claim 15, wherein the predetermined time is also based on an average deviation historical cold start times to provision the scalable resource instance.

17. The system of claim 10, wherein the startup function configured to consume the started scalable resource instance is a serverless startup function.

18. A method comprising:
determining, by a computing device, a time a scalable resource instance is needed to service a request;
determining, by the computing device, an average cold start time to start up a new scalable resource instance; and
sending, by the computing device, a request to provision the scalable resource instance at a time that is the average cold start time prior to the time the new scalable resource instance is needed.

19. The method of claim 18, wherein the average cold start time is determined from records of historical cold start times needed to start up the scalable resource instances in the past.

20. The method of claim 18, further comprising:
determining, by the computing device, an average deviation in the cold start times to start up the new scalable resource instance; and
sending, by the computing device, the request to provision the scalable resource instance at a time that is the average cold start time and the average deviation prior to the time the new scalable resource instance is need.
